(19) United States
(12) Patent Application Publication
(10) Pub. No.: US 2007/0291175 A1
(43) Pub. Date: Dec. 20, 2007

(54) DISPLAY SYSTEM, TV RECEIVER, AND METHOD FOR REMINDING A SCHEDULE

(75) Inventor: Sheng-Jin HSIEH, Hsinchu City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MEDIATEK, INC., Hsin-Chu City (TW)

(21) Appl. No.: 11/425,036

(22) Filed: Jun. 19, 2006

(51) Int. Cl. H04N 5/45

(52) U.S. Cl. 348/565

(57) ABSTRACT

A display system, a TV receiver, and a method for reminding a schedule are provided. The display system comprises a display, a TV receiver, and a controller. The display comprises a first screen and a second screen. The TV receiver, configured to receive a first source and a second source, comprises a memory for storing a schedule of the second source, a time provider for providing time, a control processor for comparing the schedule with a predetermined period of time based on the time and for generating a control signal according to the comparison, and an interface for outputting the second source to the second screen in response to the control signal while outputting the first source to the first screen. The controller inputs a signal to the control processor, wherein the signal is related to a time reminder for the second source and the predetermined period of time. When the time comes, the display system visually reminds the viewer of the desired program.

### CROSS-REFERENCES TO RELATED APPLICATIONS

Not applicable

### BACKGROUND OF THE INVENTION

1. Field of the Invention

The present invention relates to a display system, a TV receiver, and a method for visually reminding viewers of scheduled television programs.

2. Descriptions of the Related Art

Televisions are commonly used in many families. Often times, people obtain television program times from a program schedule printed in a newspaper, a TV channel that specifically lists schedules, or an electronic program guide (EPG). Unfortunately, some viewers may miss a desired program because they are distracted by another program.

With the rapid progress of technology, a television screen is capable of supporting many other electronic appliances, such as multimedia players or computers. When a multimedia of a multimedia player is displayed on the television screen, it also may cause the viewer to miss their desired television program.

U.S. Pat. 6,388,715 discloses a TV receiver shown in FIG. 1. The TV receiver 1 comprises a tuner/demodulator 101, a video processor (VP) 103, an audio processor (AP) 105, a display screen (DS) 107, a speaker 109, a control processor 111, a remote control device 113, and an EPG extraction circuit (EC) 115. When a viewer is watching a TV program, the tuner/demodulator 101 applies a video signal and an audio signal of the TV program to the video processor 103 and the audio processor 105, respectively. Then, the video signal and the audio signal are displayed via the display screen 107 and the speaker 109, respectively. An EPG extracted by the EPG extraction circuit 115 is shown as several pictograms. Each of the pictograms represents one category of programs. If the viewer sends a command to set a reminder time for a desired program via the remote control device 113, the control processor 111 would process an alert signal according to the command. Once the set time is reached, the alert signal is sent to the speaker 109 so that a sound is played to remind the viewer.

Though the TV receiver 1 can remind the viewer that the desired program is about to start, the alert sound can still be easily mixed with the sound of the currently-watched program. As a result, the viewer may not hear the alert sound. Therefore, an efficient way of reminding viewers of scheduled programs is still needed in the industrial field.

### SUMMARY OF THE INVENTION

An object of this invention is to provide a TV receiver electrically connected to a display with a first screen and a second screen. The TV receiver receives a first source and a second source, wherein one of the first source and the second source is digital. The TV receiver comprises a memory, a time provider, a control processor, and an interface. The memory is configured to store a schedule of the second source. The time provider is configured to provide time. The control processor is configured to compare the schedule with a predetermined period of time based on the time and to generate a control signal according to the comparison. The interface is configured to output the second source to the second screen in response to the control signal while outputting the first source to the first screen.

Another object of this invention is to provide a method for, while displaying a first source, reminding of a schedule of a second source on a display with a first screen and a second screen, wherein one of the first source and the second source is digital. The method comprising: storing the schedule of the second source; providing time; comparing the schedule with a predetermined period of time based on the time; generating a control signal according to the comparison; and outputting the second source to the second screen in response to the control signal while outputting the first source to the first screen.

Another object of this invention is to provide a TV receiver electrically connected to a display with a first screen and a second screen. The TV receiver receives a first source and a second source, and one of the first source and the second source is digital. The first source is outputted to the first screen. The TV receiver comprises a memory, a time provider, a control processor, and an interface. The memory is configured to store a schedule of the second source. The time provider is configured to provide time. The control processor is configured to compare the schedule with a predetermined period of time based on the time and configured to generate a control signal according to the comparison. The interface is configured to stop outputting the first source to the first screen and output the second source to the first screen in response to the control signal.

Another object of this invention is to provide a method for, while displaying a first source on a first screen, reminding of a schedule of a second source on a display with the first screen and a second screen. One of the first source and the second source is digital. The method comprises: storing a schedule of the second source; providing time; comparing the schedule with a predetermined period of time based on the time; generating a control signal according to the comparison; stopping outputting the first source to the first screen in response to the control signal; and outputting the second source to the first screen in response to the control signal.

Another object of this invention is to provide a display system. The display system comprises a display, a TV receiver, and a controller. The display comprises a first screen and a second screen. The TV receiver receives a first source and a second source. The controller inputs a signal which is related to a time reminder for the second source. The TV receiver outputs the second source to the second screen in response to the signal while outputting the first source to the first screen.

Yet a further object of this invention is to provide a TV receiver electrically connected to a display with a first screen and a second screen. The TV receiver receives a first source and a second source, wherein one of the first source and the second source is digital. The TV receiver comprises: means for storing a schedule of the second source; means for providing time; means for comparing the schedule with a predetermined period of time based on the time and for generating a control signal according to the comparison; and means for outputting the second source to the second screen in response to the control signal while outputting the first source to the first screen.

When the schedule occurs, a visual reminder on the second screen is displayed. Such a reminder is noticeable and difficult to ignore.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a block diagram of a conventional TV receiver;

FIG. 2 shows a block diagram of a first embodiment in accordance with the present invention;

FIG. 3 shows a block diagram of a TV receiver of the first embodiment;

FIG. 4 shows an example of a visual reminder in accordance with the present invention;

FIG. 5 shows another example of a visual reminder in accordance with the present invention; and

FIG. 6 shows a flow chart of a second embodiment in accordance with the present invention.

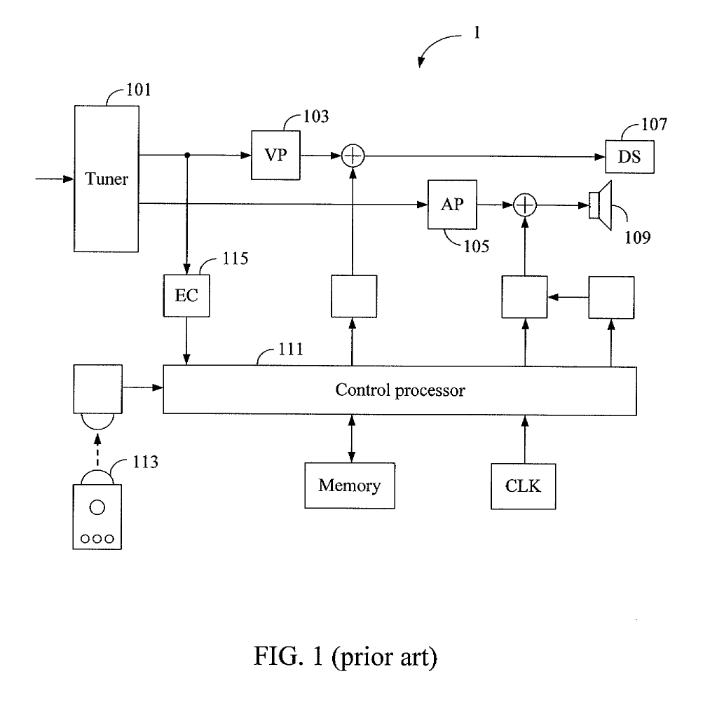

### DESCRIPTION OF THE PREFERRED EMBODIMENT

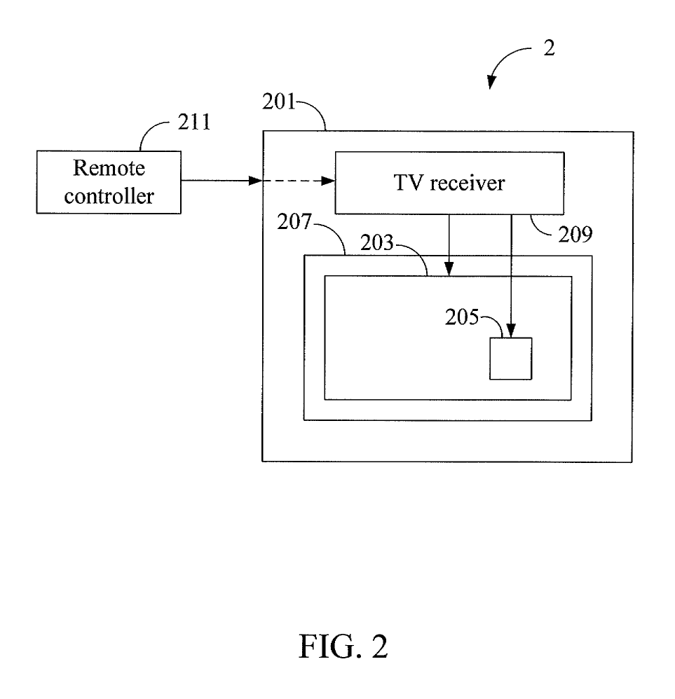

FIG. 2 shows a block diagram of a display system in accordance with the present invention. In this first embodiment, the display system 2 comprises a TV set 201 and a remote controller 211. The TV set 201 comprises a display 207 and a TV receiver 209, wherein the display 207 is capable of simultaneously displaying two sources on a first screen 203 and a second screen 205. The TV receiver 209 is configured to receive the two sources, a first source and a second source. The remote controller 211 is configured to input a signal set by a viewer, wherein the signal serves as the time reminder for the second source. When schedule of the time reminder occurs, the TV receiver 209 outputs the second source to the second screen 205 while the first source is outputted to the first screen 203.

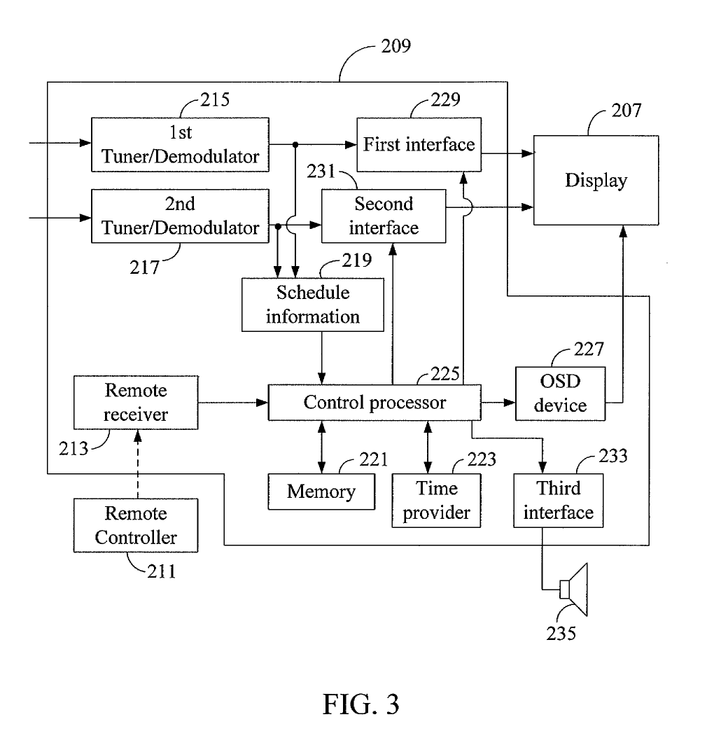

The following descriptions are more detailed descriptions of the first embodiment As shown in FIG. 3, the TV receiver 209 comprises a remote receiver 213, a first tuner/demodulator 215, a second tuner/demodulator 217, a schedule information device 219, a memory 221, a time provider 223, a control processor 225, an OSD device 227, a first interface 229, a second interface 231, and a third interface 233. The first tuner/demodulator 215 and the second tuner/demodulator 217 are configured to receive the first source and the second source, respectively. In this embodiment, both the first source and the second source are digital TV sources, each of them carrying their own EPG The two EPGs are transmitted to the schedule information device 219. The time provider 223 is configured to provide time. This time provider 223 may be an internal clock generator or a timing receiving device that receives time information from the outside.

When the viewer wants to read a program schedule of the first source or the second source, the viewer inputs an instruction via the remote controller 211. The instruction is converted to a wireless signal which is received by the remote receiver 213. The control processor 225 controls the first interface 229 or the second interface 231 to transmit the corresponding EPG to the display 207 in response to the instruction. The viewer may read the program schedule thereby.

For example, if the viewer wants to read the program schedule of the second source, the EPG of the second source is shown on the display 207. After reading the program schedule, the viewer selects one of the programs and sets a predetermined period of time to remind himself or herself of the schedule of the desired program. The predetermined period of time also corresponds to a period of time before the desired program starts. Thus, the viewer may set the predetermined period of time as, for example, 10, 5, or 3 minutes. A visual message will be shown on the display 207, when the time comes, to remind the viewer.

After receiving an instruction for setting the predetermined period of time, the remote receiver 213 passes it to the control processor 225. The control processor 225 then stores the information in the memory 221. In addition to the schedule of the second source, the memory 221 also stores the predetermined period of time, wherein the schedule of the second source comprises the schedule of the desired program. It is noted that this embodiment may alternatively support a manual input to store the schedule of the desired program via the remote controller 211.

Thereafter, the control processor 225 compares the schedule of the desired program with the predetermined period of time based on the time generated by the time provider 223. When the time is close to the schedule around the predetermined period of time, the control processor 225 generates a control signal and sends it to the second interface 231. The second interface 231 outputs the desired program to the second screen 205 in response to the control signal. Meanwhile, the first screen 203 is displaying a program of the first source. For example, if the desired program will start at 8:00 PM and the predetermined period of time is set as 10 minutes, the desired program will be displayed on the second screen 205 at 7:50 PM to remind the viewer while the viewer is watching the program of the first source on the first screen 203.

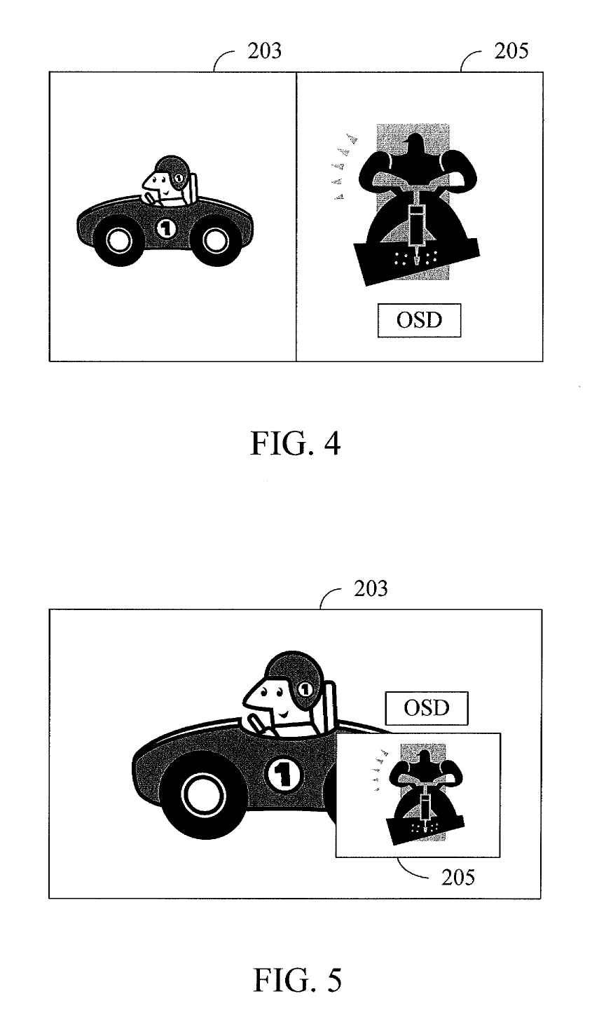

In this embodiment, a second reminder is used. The second reminder of the desired program is illustrated via a visual message as well. More particularly, the second reminder is texture information displayed in an on screen display (OSD) format, wherein the texture information may comprise the remaining time until the beginning of the desired program or the title of the desired program. When the time is close to the schedule around the predetermined period of time, the control processor 225 transmits a signal to the OSD device 227. The signal carries the above-mentioned texture information. The OSD device 227 then transmits the texture information to the display 207 which displays the texture information in an OSD format. The OSD can be arranged at any position of the first screen 203 or the second screen 205. FIG. 4 shows an example of the OSD overlapping with the second screen 205. The first screen 203 and the second screen 205 are arranged as a picture-on-picture (POP) form. FIG. 5 shows another example of the OSD overlapping with the first screen 203. The first screen 203 and the second screen 205 are arranged as a picture-in-picture (PIP) form.

In this embodiment, a third reminder is used. When the time is close to the schedule around the predetermined period of time, the control processor 225 also sends a signal to the third interface 233. The third interface 233 generates an audio signal to a speaker 235 in response to the signal. The speaker 235 plays a sound to remind the viewer thereby.

In the first embodiment, the first source does not have to be limited to a digital TV source. For example, the first source may be derived from a multimedia player, such as a VCD player and a DVD player.

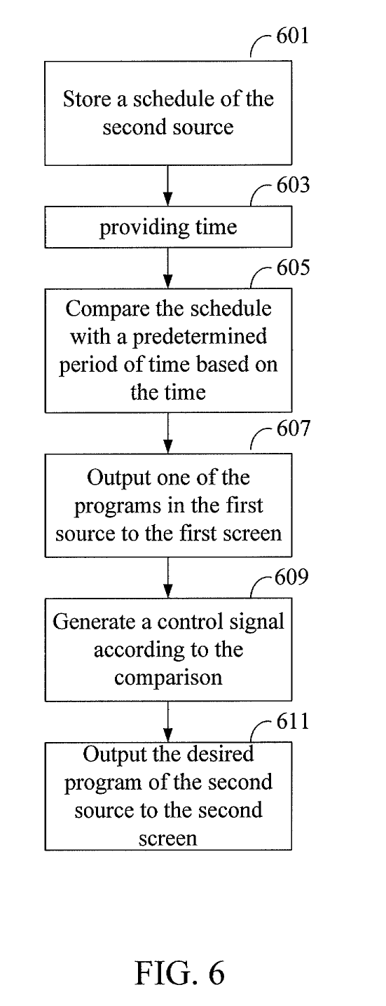

A second embodiment of the present invention is a method, while displaying a first source, for reminding viewers of a schedule of a second source on a display with a first screen and second screen. The method is adapted for a TV receiver, as noted in the first embodiment. In addition, in this second embodiment, both the first source and the second source are digital TV sources. FIG. 6 shows a flow chart of the method. In step 601, storing a schedule of the second source is executed, wherein the schedule comprises the schedule of a desired program of the second source, which is set by reference to an EPG or a manual input. In step 603, time is provided. Then step 605 is executed to compare the schedule with a predetermined period of time based on the time. Step 607 is then executed to output one of the programs in the first source to the first screen. After that, Step 609 is executed wherein a control signal is generated according to the comparison. More particularly, the control signal is generated when the time is exactly equal to the schedule minus the predetermined period of time. Finally, step 611 is executed to output the desired program of the second source to the second screen in response to the control signal while the first source continues being outputted to the first screen.

The method may further comprise the step of providing a clock generator or a timing receiving device to provide time in step 603.

In addition to the steps shown in FIG. 6, the second embodiment is able to execute all of the operations or functions noted in the first embodiment.

A third embodiment of the present invention is a TV receiver, which is capable of being applied in the display system recited in the first embodiment. In contrast to the first embodiment, the first interface of the third embodiment stops outputting the first source to the first screen in response to the control signal when the time comes. Then the first interface starts to output the second source to the first screen. The second interface outputs the first source to the second screen in response to the control signal when the time comes so that the viewer is reminded of the program of the second source on the first screen and is able to keep watching the program of the first source on the second screen.

A fourth embodiment of the present invention is a method, while displaying a first source, for reminding viewers of a schedule of a second source on a display with a first screen and second screen. This method is adapted for a TV receiver, as noted in the third embodiment. In contrast to the second embodiment, step 611 is replaced in the fourth embodiment with the steps of stopping outputting the first source to the first screen in response to the control signal, outputting the second source to the first screen, and outputting the first source to the second screen.

In addition to the recited steps, the fourth embodiment is able to execute all of the operations or functions noted in the third embodiment.

The present invention provides a solution to visually reminding viewers of approaching TV programs so that the viewers will not miss the desired television programs.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A TV receiver electrically connected to a display with a first screen and a second screen, the TV receiver receiving a first source and a second source, one of the first source and the second source being digital, comprising:
a memory for storing a schedule of the second source;
a time provider for providing time;
a control processor for comparing the schedule with a predetermined period of time based on the time and for generating a control signal according to the comparison; and
an interface for outputting the second source to the second screen in response to the control signal while outputting the first source to the first screen.

2. The TV receiver as claimed in claim 1, wherein content of the second source is illustrated via a visual message on the display.

3. The TV receiver as claimed in claim 2, wherein the visual message is in an on screen display (OSD) format.

4. The TV receiver as claimed in claim 1, wherein an audio signal, played by a speaker, reminds of the schedule.

5. The TV receiver as claimed in claim 1, wherein the time provider is a clock generator.

6. The TV receiver as claimed in claim 1, wherein the time provider is a timing receiving device.

7. The TV receiver as claimed in claim 1, wherein the first source is outputted to the first screen before the control signal is generated.

8. The TV receiver as claimed in claim 1, wherein the schedule is created by reference to an electronic program guide (EPG).

9. The TV receiver as claimed in claim 1, wherein the schedule is created by reference to a manual input.

10. The TV receiver as claimed in claim 1, wherein the second source is a digital TV source.

11. The TV receiver as claimed in claim 10, wherein the first source is the digital TV source.

12. A method for, while displaying a first source, reminding of a schedule of a second source on a display with a first screen and a second screen, one of the first source and the second source being digital, the method comprising:
storing the schedule of the second source;
providing time;
comparing the schedule with a predetermined period of time based on the time;
generating a control signal according to the comparison; and
outputting the second source to the second screen in response to the control signal while outputting the first source to the first screen.

13. The method as claimed in claim 12, further comprising a step of illustrating content of the second source via a visual message on the display.

14. The method as claimed in claim 13, wherein the visual message is in an on screen display (OSD) format.

15. The method as claimed in claim 12, further comprising a step of playing an audio signal to remind of the schedule.

16. The method as claimed in claim 12, further comprising a step of providing a clock generator, wherein the step of providing time is executed by the clock generator.

17. The method as claimed in claim 12, further comprising a step of providing a timing receiving device, wherein the step of providing time is executed by the timing receiving device.

18. The method as claimed in claim 12, further comprising a step of outputting the first source to the first screen before the step of generating a control signal is executed.

19. The method as claimed in claim 12, wherein the schedule is created by reference to an electronic program guide (EPG).

20. The method as claimed in claim 12, wherein the schedule is created by reference to a manual input.

21. The method as claimed in claim 12, wherein the second source is a digital TV source.

22. The method as claimed in claim 21, wherein the first source is the digital TV source.

23. A TV receiver electrically connected to a display with a first screen and a second screen, the TV receiver receiving a first source and a second source, one of the first source and the second source being digital, the first source being outputted to the first screen, the TV receiver comprising:
a memory for storing a schedule of the second source;
a time provider for providing time;
a control processor for comparing the schedule with a predetermined period of time based on the time and for generating a control signal according to the comparison; and
an interface for stopping outputting the first source to the first screen and for outputting the second source to the first screen in response to the control signal.

24. The TV receiver as claimed in claim 23, wherein the interface further outputs the first source to the second screen in response to the control signal.

25. A method for, while displaying a first source on a first screen, reminding of a schedule of a second source on a display with the first screen and a second screen, one of the first source and the second source being digital, the method comprising:
storing a schedule of the second source;
providing time;
comparing the schedule with a predetermined period of time based on the time;
generating a control signal according to the comparison;
stopping outputting the first source to the first screen in response to the control signal; and
outputting the second source to the first screen in response to the control signal.

26. The method as claimed in claim 25, further comprising the step of outputting the first source to the second screen in response to the control signal.

27. A display system, comprising:
a display comprising a first screen and a second screen;
a TV receiver for receiving a first source and a second source; and
a controller for inputting a signal, the signal being related to a time reminder for the second source;
wherein the TV receiver outputs the second source to the second screen in response to the signal while outputting the first source to the first screen.

28. A TV receiver electrically connected to a display with a first screen and a second screen, the TV receiver receiving a first source and a second source, one of the first source and the second source being digital, comprising:
means for storing a schedule of the second source;
means for providing time;
means for comparing the schedule with a predetermined period of time based on the time and for generating a control signal according to the comparison; and
means for outputting the second source to the second screen in response to the control signal while outputting the first source to the first screen.
